(19) United States
(12) Patent Application Publication
(10) Pub. No.: US 2018/0351816 A1
(43) Pub. Date: Dec. 6, 2018

(54) Methods and apparatus for parameter tuning using a cloud service

(71) Applicant: Yan Li, Scotts Valley, CA (US)

(72) Inventor: Yan Li, Scotts Valley, CA (US)

(21) Appl. No.: 15/996,425

(22) Filed: Jun. 1, 2018

Related U.S. Application Data
(60) Provisional application No. 62/514,137, filed on Jun. 2, 2017.

(51) Int. Cl. H04L 12/24; G06Q 30/02; G06N 99/00; H04L 29/08

(52) U.S. Cl. CPC H04L 41/14; G06Q 30/0283; H04L 12/66; H04L 67/10; H04L 41/16; G06N 99/005

(57) ABSTRACT

We describe a method and apparatus for optimizing a subject system that has measurable state values and tunable parameters. The method and apparatus comprising: identifying status values of the target system to collect, parameters of the subject system to tune, a tuning goal, and a parameter tuning logic; and deploying the parameter tuning logic in one or more clouds or reusing one or more existing instances of the parameter tuning logic in one or more clouds; and reading the state values and the parameter values (values of the said parameters) of the subject system at intervals; and transmitting the state values and the parameter values of the subject system to the clouds at intervals; and computing parameter tuning instructions by the parameter tuning logic at intervals; and transmitting the parameter tuning instructions from the clouds to the subject system at intervals; and executing the parameter tuning instructions at intervals. The advantage of the embodiments of the inventive method and apparatus includes easy setup, high flexibility, high reliability, and low cost.

### CROSS REFERENCE TO RELATED APPLICATIONS

This application claims the benefit of U.S. Provisional Application No. 62/514,137, filed Jun. 2, 2017 by the present inventor.

### BACKGROUND

The following is a tabulation of some prior art that presently appears relevant:

### U.S. Patent Application Publications

| Publ. Number | Kind Code | Publ. Date | Applicant |
|---|---|---|---|
| 2015/0019707 | A1 | 2015 Jan. 15 | Raghunathan et al. |
| 2015/0019700 | A1 | 2015 Jan. 15 | Masterson et al. |
| 2012/0047240 | A1 | 2012 Feb. 23 | Keohane et al. |

### U.S. Patents

| Patent Number | Kind Code | Issue Date | Patentee |
|---|---|---|---|
| 9,438,648 | B2 | 2016 Sep. 6 | Asenjo et al. |
| 9,477,936 | B2 | 2016 Oct. 25 | Lawson et al. |

### Nonpatent Literature Documents

Li et al. The 2017 International Conference for High Performance Computing, Net-working, Storage and Analysis (Supercomputing 2017), “CAPES: Unsupervised Storage Performance Tuning Using Neural Network-Based Deep Reinforcement Learning”. Denver, Colo., USA: Nov. 13-16, 2017.

All computer systems have tunable parameters. A parameter can be set to a certain value, and the values of these parameters change how the systems behave and offer a means to customize the system to meet different user requirements. A computer system can have hundreds of tunable parameters, and the following are some commonly seen parameters. Small electronic devices, such as smartphones or Internet of Things, have parameters that control how they draw power from the power source, how often they send or receive data through a network, how bright their screens should be, etc. Large distributed systems, such as High Performance Computing (HPC) clusters or the computers in a data center, have parameters that control how many applications are allowed to run in parallel, how fast a Network Interface Card should limit their network traffic, the size of the TCP congestion window size, etc. Software systems have parameters too. For instance, a database system usually provides parameters for tuning the number of dispatcher processes, the size of database buffer cache, enable or disable connection pooling, enable or disable session multiplexing, etc. An HTTP server system can provide parameters that control how many worker threads the server needs to maintain, the maximum number of connections that each worker should handle, the number of requests a client can make over a single keepalive connection, etc.

Users tune these parameters to meet their requirements of the subject system. Some user might want to maximize the processing throughput of a system, while another user may need to minimize the processing latency. Some user may require a high write throughput for a write-only workload, and another user may require a high read throughput for a read-only workload. The subject system's parameters have to be tuned accordingly to meet these different requirements. The setting of certain parameters also depends on the underlying supporting system.

Parameters tuning can have a great impact on the subject system's performance. A well tuned system can vastly outperform its performance before tuning, and a badly or untuned system can only offer a fraction of its performance capabilities. It is in the user's best interest to keep their computer systems, especially high cost systems, such as data centers or supercomputers, running at peak performance. For these systems, even a 1% increase in performance can usually mean a saving of hundreds of thousands of dollars. Smaller enterprise computing systems can also see a considerable performance boost when parameters are tuned to match the user's specific environment and workloads.

However, parameter tuning is challenging and time consuming. The optimal parameter values depend on many factors, such as what workload the subject system is processing, what the user wants to tune the subject system for, the hardware, the software, the network topology, and so on. For instance, the maximum number of worker threads an HTTP server should maintain depends on the number of CPUs of the underlying hardware, the amount of RAM, the bandwidth of the Network Interface Card, etc. Exceeding the limits that the hardware can sustain can sometimes result in unstable system. Another sample is that the optimal TCP congestion window size depends on how the network is organized, the throughput of the server's network hardware, and how the user application sends and receives data. The optimal parameter values can also be affected by other seemingly trivia aspects of the system. For instance, the security patches to fix the Intel Meltdown and Spectre vulnerabilities could slow down the performance of affected machines by 20 to 30 percent (Researchers Discover Two Major Flaws in the World's Computers, The New York Times, Jan. 3, 2018). This change in performance has a rippling effect to how the user should tune the parameter values to achieve the optimal performance.

Therefore, parameter tuning usually requires the involvement of both domain experts and the end user, and very often includes numerous cycles that consist of benchmark, information gathering, analysis, and trial tweaking steps. It requires painstakingly collecting a large amount of data about both the static and runtime information of the subject system, and meticulous following a complex performance tuning manual or mathematical models. These tasks can take from weeks to months to finish. In certain situations, the tuning process requires continual monitoring and analyzing of the workloads.

Because manual parameter tuning can take such a big effort and a long time, it mostly focuses on identifying and fixing issues, or testing a few known options on the user's specific workloads. Certain tuning methods and guides provide a limited number of options for the user to experiment with and see which one can lead to a higher performance, but systematic exploring the available parameter space with the goal of identifying optimal settings that boost system performance for running the user's specific workloads is not what can be easily done in a few weeks or possible with the level of resources most users can offer.

Recently advances in machine learning and artificial intelligence technologies have made it possible to use them to build automatic performance tuning system (“CAPES: Unsupervised Storage Performance Tuning Using Neural Network-Based Deep Reinforcement Learning”. The 2017 International Conference for High Performance Computing, Networking, Storage and Analysis (Supercomputing 2017), Denver, Colo., USA: Nov. 13-16, 2017). Such machine learning-based parameter tuning systems analyze the status information of the subject system and generate new parameter values in an automatic manner and require little to no human input. An automatic performance tuning system has several advantages over traditional manual parameter tuning done by domain experts and IT administrators. First, it can explore a larger combination of parameters that few humans could afford, potentially leading to better tuning results. Second, it does not require hiring domain experts or consultants and can greatly reduce the human-related costs. Third, an automatic system can tirelessly analyze and tune the computer system 24×365, which few human teams could afford.

On the other hand, these automatic and machine learning-based tuning systems have their own high costs and usability issues. First is the high initial cost of acquiring related hardware and software for running these tuning systems. As we have stated before, because the optimal parameter values depend on almost all aspects of a subject system, all these information has to be collected as input for the tuning system. As an example, even a medium sized computer system can generate a large amount of status information, which include the static and runtime status of the subject system. The static status information about a computer systems includes details about the system that are not changing when the system runs, such as the specification of the system's hardware and software (e.g. the amount of RAM, the number of processors, the cache size of each processor, the version of the operating system, and the network topology). The runtime information of a computer reflects the status of the system at a given moment, and can include measurements such as the CPU utilization rate, the memory usage, the input/output speed of each disks and network interface cards, etc. The runtime status can be read from the internal measurement or debugging mechanism of the computer system, calculated as statistics by aggregating measurement data of the system, or collected from peripheral devices that support the system. A complex computer systems, especially distributed systems that consist of hundreds or thousands of nodes, can produce a huge amount of measurement data. Therefore, the automatic or machine learning-based analytic process usually needs to process a huge amount of status information from the subject system in order to decide on the optimal parameter values, and can require a considerable amount of computational power. Certain machine learning models require using a Graphics Processing Unit (GPU), which is superior to a traditional Central Processor Unit (CPU) in terms of processing a large amount of data in parallel. Because of this high demand on computational power, these tuning model and software usually need to be deployed on dedicated high performance hardware, which can lead to high procurement and management cost.

These high initial deployment cost is probably one of the major reasons that such parameter tuning methods are not being widely used in practice, because it is hard to justify the cost when their effect on performance gain cannot be guaranteed. The actual effect of applying a certain machine learning or analytic performance tuning model is almost impossible to predict; in practice, the only way to be sure is to conduct a trial run of these models on the user's system.

In addition to these initial hardware/software procurement and setup costs, there are other hurdles that a user has to face. For instance, such a tuning system usually requires a dedicated team that consists of data analysts and machine learning experts to maintain, potentially incurring high human cost it was designed to save in the first place. Moreover, when the subject system needs to scale out (expanding by adding new hardware), the coupled tuning system also needs to be expanded to cope with the increase in the amount of incoming data.

Another weakness of these automatic and machine learning-based tuning systems lies in the nature of machine learning algorithms. Most machine learning algorithms require processing a large amount of training data before they can produce meaningful results, and the quality of the algorithm's output is usually proportional to the amount of training data. In other words, in order to achieve good parameter tuning results, analyzing a huge amount of training data is required. For automatic and machine learning-based tuning systems that are deployed along with the user's computer system, they only have access to one user's data, often limiting to one or a few subject systems. Not being able to carry out cross-system or cross-user analyses, these systems are not able to take advantage of data or models from other similar computers, often restricting the effectiveness of their machine learning algorithms.

If a user needs 24×7 continual tuning of a subject system, these automatic and machine learning-based tuning systems need to be highly available. They need to be able to keep functioning in cases of power loss or hardware failure. This requirement demands that the tuning system's hardware to be highly reliable, which is usually achieved by building redundancy into every module of the tuning system, further increasing the deployment and management cost.

If the application or workload on the subject system is relatively stable and does not require constant monitoring, the added hardware and software for constructing the model would not be needed after the initial set up period. However, complex and power hardware and software are still needed during the initial construction of the model or analysis of historical data before a model that precisely match the subject system can be constructed. Therefore, the high cost of the expensive hardware and software still cannot be avoided.

The tuning system is usually attached to the same power supply of the subject system. For heavy computational tasks, the tuning system itself can consume a considerable wattage of power, increasing the load of the power supply and shortening the run time when the power supply has to run on battery.

Another disadvantage is that starting and stopping the tuning system can be slow. This is, again, because of the large volume of the data the tuning system has to process. Certain types of tuning systems need to load a large amount of data into RAM to accelerate the analytic speed, and depending on the volume of the data, the loading process can take from dozens of minutes to hours, which is a cumbersome process that have to be carried out every time the tuning system has to be restarted or power supply is lost.

Existing cloud performance tuning solutions generate reports that have to be read or executed by a human, causing a long delay before proposing a change to the parameters and actually deploying the change. Reading and executing a report also limit the frequency the tuning can be done, usually to a few times every month at best, and are not capable of handling rapidly changing workloads, which can change significantly in a few seconds, especially when important or unexpected events or errors occur. Because of the slowness, existing cloud performance tuning solutions focus on identifying issues of a subject system by following predefined rules, and none of them could systematically or intelligently explore a large space of parameter values with the goal to discover optimal parameter values that match the specific hardware/software combination of the subject system and the unique workloads the subject system is running, and tweaking the parameter values continuously in order to quickly response to a change in the workload. Another problem of existing cloud performance tuning solutions is that they require a specific architecture or a specific type of hardware or software of the subject system, mainly for supporting being managed by a system running in the cloud. They could not support existing systems or systems from a third party supplier that do not support being managed.

### SUMMARY

Embodiments of the invention provide systems and methods for tuning the parameters of a subject system. The method comprises: identifying status values of the target system to collect, parameters of the subject system to tune, a tuning goal, and a parameter tuning logic; and deploying the parameter tuning logic in one or more clouds or reusing one or more existing instances of the parameter tuning logic in one or more clouds; and reading the state values and the parameter values (values of the said parameters) of the subject system at intervals; and transmitting the state values and the parameter values of the subject system to the clouds at intervals; and computing parameter tuning instructions by the parameter tuning logic at intervals; and transmitting the parameter tuning instructions from the clouds to the subject system at intervals; and executing the parameter tuning instructions at intervals.

We use the term “logic” to mean a method, a module, a process, or an algorithm, depending how the embodiment is implemented. For instance, the parameter tuning logic can be a machine learning method that is implemented using a piece of computer equipment, using one or more pieces of integrated circuit board, using one or more Central Processing Units and/or Graphics Processing Units, using a cluster of computers that have many nodes, or using a group of virtual machine instances running in a cloud, etc.

The owner of the subject system operates the subject system. A Cloud Tuning Service provider operates the logic and modules in the cloud. The Cloud Tuning Service provider is also in charge of choosing one or more computing clouds to deploy the parameter tuning logic. A computing cloud (or just a “cloud”) is a pool of configurable computing resources and higher-level services that can be rapidly provisioned with minimal management effort, often over the Internet. Amazon Web Service, Google Cloud Platform, Microsoft Azure, and others who provide similar services are all cloud providers. The Cloud Tuning Service provider acquires computing resources from one or more cloud providers and deploys the parameter tuning logic, as well as other supporting services, in the cloud, and provides access and services to the subject system owner. It should be noted that the Cloud Tuning Service provider is different from a cloud provider. The former provides parameter tuning services and the latter provides computing resources, such as virtual machines and database services that are needed for deploying the parameter tuning logic. In practice, the subject system owner, the Cloud Tuning Service provider, and the cloud provider are usually different entities, but some of they can also be the same entity. For instance, a large cloud provider can also provide Cloud Tuning Services, or an institute can own both the Cloud Tuning Service and the subject system.

The subject system can be any system that includes parameters that can be changed, such as electronic systems, computer systems, smartphones, laptops, Internet of Things, Supervisory control and data acquisition (SCADA) systems, industrial control systems, database software systems, operating systems, medical devices, and so on. In addition to parameters, the subject system also needs to provide a means to detect or measure its state values, which reflect the operational status of the subject system. State values cover all kinds of data that can be collect from the subject system. For example, performance metrics, such as how many transactions are processed every second and how many bytes of data are read every second, is a kind of state values; and CPU usage, memory usage, power usage, etc., are also state values.

The User's Manual and other documentations of the subject system can be used as a reference to determine what state value and parameters should be included. The subject system owner can work with a Cloud Tuning Service provider to determine the state values to collect and the parameters to tune. The Cloud Tuning Service provider can prepare a predefined set of state values and a set of parameters for common subject systems, optionally with the help of domain experts.

The parameter tuning logic has three sets of inputs: the tuning goal, the state values, and the parameter values. It may use a database to store historical values or retrieve data from database on demand. The parameter tuning logic implements a method of analyzing the state values and parameter values, and generating parameter tuning instructions that can achieve the tuning goal. There are many ways to implement the parameter tuning logic. A lookup table is such a method. Neural networks, reinforcement learning, and other similar machine learning and artificial intelligence methods can also be used.

The state values and parameter values are collected and transmitted to the parameter tuning logic in the cloud periodically. The parameter tuning logic analyzes the state values and parameter values, and generates parameter tuning instructions periodically. The parameter tuning instructions can have many different forms. For instance, a desired value for a parameter is a form of parameter tuning instruction. Increasing the value of a certain parameter by a certain amount is a form of parameter tuning instruction. Increasing the value of a certain parameter by a certain amount at certain intervals is also a parameter tuning parameter. Any instruction that changes the value of a parameter is a parameter tuning instruction.

The parameter tuning instructions are transmitted back to the subject system periodically. The parameter tuning instructions are then executed to change the according parameters periodically.

Deploying the parameter tuning logic in the cloud has many advantages for both the subject system owner and Cloud Tuning Service provider. The up-front infrastructural cost and management cost of the subject system owner will be reduced. The time for tuning the parameters of a subject system can be greatly shortened. Acquiring resources from one or more cloud provider and the automation of the management of parameter tuning logic will make it possible for the Cloud Tuning Service provider to construct a simple, consistent pricing and contracting model for customers, which will simplify the planning, budgeting, and provisioning of parameter tuning for the subject system owner. The subject system owner will be able to evaluate and use different parameter tuning logic from different Cloud Tuning Service providers. Competition in the cloud parameter tuning service market will further reduce the subject system owner's costs and increase service quality.

A method for tuning the parameters of a subject system can further comprise deploying one or more client agents to the subject system with instructions to read the statue values, and to read and set parameter values of the subject system; and reading the state values and the parameter values of the subject system by the client agent at intervals; and executing the parameter tuning instructions by the client agents at intervals. Client agents are needed when there is no existing method to collect the state values or the parameter values, or to set the parameter values. If the subject system provides existing methods for collecting state values and parameter values, or setting the parameter values, they could be used too.

Using client agents to collect state values and parameter values, and to set parameter values makes it possible to tune the parameters of existing systems that do not provide a way to collect or transmit these values. The client agents can be provided by the Cloud Tuning Service provider or be designed by the subject system owner by following a certain protocol that is provided by the Cloud Tuning Service provider. Alternatively or additionally, the client agents can have a modular architecture that supports loading plugins or addons to expand its functions of collecting state values and parameter values, and setting parameter values.

A method for tuning the parameters of a subject system can further comprise acquiring resources from a public or a private cloud; and releasing the resources when they are no longer needed. By releasing the resources when they are no longer needed, the Cloud Tuning Service provider can scale up or down its cost to match the subject systems it needs to serve.

A method for tuning the parameters of a subject system can further comprise counting the duration of a subject system's tuning time, the number of the state values, and/or the number of parameters the tuning involves to decide how much the subject system owner should pay for the service. By providing a consistent pricing model, the Cloud Tuning Service provider can simplify the service contract for new subject systems.

A method for tuning the parameters of a subject system can further comprise starting or stopping the tuning of a subject system on conditions. Time, a certain value of a state value, a certain value of a certain parameters, and any other conditions can be used as a trigger.

A method for tuning the parameters of a subject system can further comprise storing the state values, the parameter values, and parameter tuning instructions in a data store. These stored data can be used to train models that can be used for the parameter tuning logic or other purposes.

A method for tuning the parameters of a subject system wherein the computing of parameter tuning instructions can further comprise: using one or more machine learning or artificial intelligence methods to analyze the state values and the parameter values at intervals; and training one or more models using the state values, the parameter values, and the parameter tuning instructions from one or more subject systems at intervals; and generating parameter tuning instructions at intervals. Deep Reinforcement Learning methods have been proven to be especially effective for parameter tuning (“CAPES: Unsupervised Storage Performance Tuning Using Neural Network-Based Deep Reinforcement Learning”. The 2017 International Conference for High Performance Computing, Networking, Storage and Analysis (Supercomputing 2017), Denver, Colo., USA: Nov. 13-16, 2017). The training can also be done by using data from multiple subject systems in order to get better results.

A method for tuning the parameters of a subject system can further comprise inputting one or more Parameter Value Check functions that can be used to check the newly calculated parameter tuning instructions; and using Parameter Value Check functions to check the parameter tuning instructions before executing them. Certain machine learning and other automated methods could generate invalid values for the parameter tuning instructions, or these instructions could generate invalid or known bad combination of parameter values. The subject system's owner can input one or more Parameter Value Check functions, which will be used to check the parameter tuning instructions before executing them.

A method for tuning the parameters of a subject system can further comprise assigning negative rewards to parameter values that were ruled out by Parameter Value Check function and using them to train the parameter tuning logic to reduce the chance of generating bad parameter values in the future.

A method for tuning the parameters of a subject system can further comprise preprocessing the state values, the parameter values, or the parameter tuning instructions to reduce their sizes before transmission and/or being stored. Any preprocessing methods can be used. Compression, only transmitting values that changed, deduplication, and any other methods that can reduce data size can be used for preprocessing.

A method for tuning the parameters of a subject system can further comprise consolidating parameter tuning instructions from many parameter tuning logic.

Other advantages of one or more aspects will be apparent from a consideration of the drawings and ensuing description.

### BRIEF DESCRIPTION OF THE DRAWINGS

For a more complete understanding of the invention, reference is made to the following description and accompanying drawings, in which:

FIG. 1 is a block diagram of an embodiment of the parameter tuning method and apparatus;

FIG. 2 is a flowchart of how a subject system owner can use an embodiment of the parameter tuning method and apparatus;

FIG. 3 is a flowchart of an embodiment of the parameter tuning method and apparatus;

FIG. 4 is a flowchart of an embodiment of the data collection method; and

FIG. 5 is a flowchart of an embodiment of the parameter calculation and setting method.

### DETAILED DESCRIPTION OF THE FIRST EMBODIMENT

We describe an embodiment of the parameter tuning method that tunes the parameters of a subject system using a cloud service (also referred to as “a cloud parameter tuning method” in the following description and claims). For simplicity and illustrative purposes, the principles of the present embodiment are described by referring primarily to a computer system as the subject system. However, one of ordinary skill in the art would readily recognize that the same principles are equally applicable to, and can be implemented in, any computer, electronic system, or software systems with parameters. The subject system can be, for instance, a single desktop or workstation computer, a computer server, a smart phone, an Internet of Things device, an electronic communication device, a car, a satellite, a Supervisory Control And Data Acquisition (SCADA) system, or a computer cluster located in a data center. The parameters can include anything that is tunable. In practice, the parameters may also be referred to as configuration, settings, or options. Example of parameters are TCP congestion window size, I/Q queue depth limit, number of worker threads, buffer size, etc. The value of a parameter is called the parameter value.

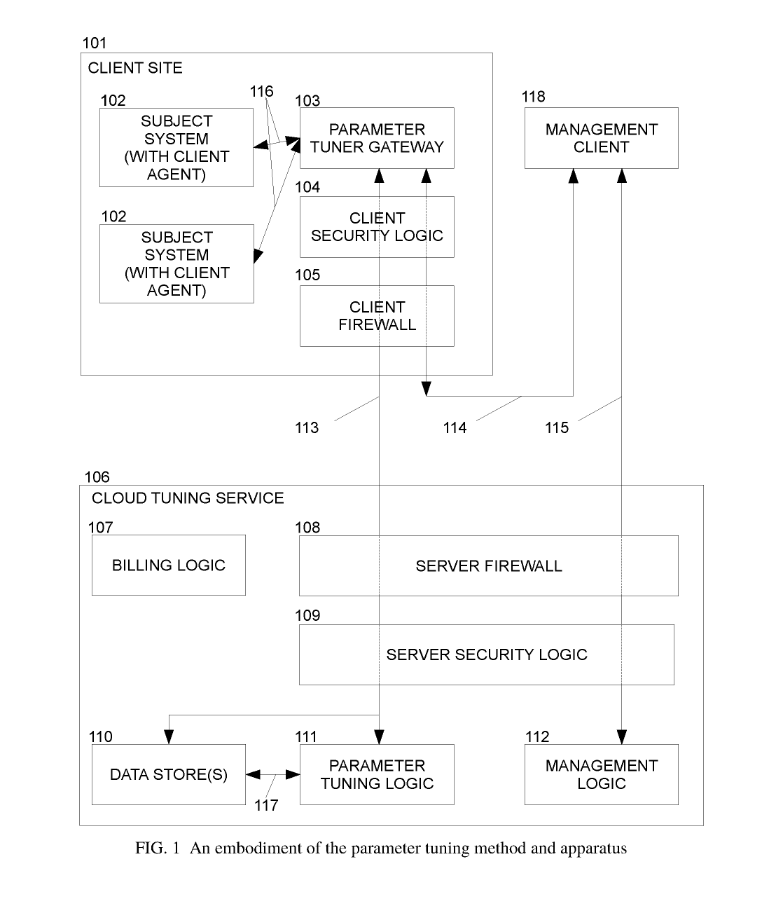

One embodiment of the method is illustrated in FIG. 1. A client site [101] has one or more subject systems [102] that need tuning. A Parameter Tuner Gateway [103] is located at the client site [101]. The Parameter Tuner Gateway [103] can be either a standalone computer or on a computer shared with other users or functions. The Parameter Tuner Gateway [103] is connected to each subject system [102] through a data transmission means [116], such as a computer network. The Parameter Tuner Gateway [103] is also connected to a Parameter Tuning Logic [111] and/or one or more data stores [110] through a data transmission means [113], such as a computer network. The Parameter Tuning Logic [111] and the data stores [110] are part of the Cloud Tuning Service [106]. The Cloud Tuning Service [106] can either be located at the client site [101] or off the customer site. When the Cloud Tuning Service [106] is located at the customer site, it is customarily called running in a private cloud; and when the Cloud Tuning Service is not located at the customer site, it is customarily called running in a public cloud.

A cloud is a platform that provides a means of acquiring and allocating computational resources, such as physical machines, virtual machines, or containers. A cloud is public when it provides services to anybody who subscribes to its service and is being shared by subscribers, like a public library. Even the cloud is public, each subscriber's data can be either accessed publicly or protected as private per the customer's choice. Public cloud is provided by many cloud providers, such as Amazon Web Service, Microsoft Azure, and Google Cloud Platform. A private cloud only provides service to a limited number of subscribers, and can be operated by either a public cloud provider through a special contract, or by any other organization. The Cloud Tuning Service can be set up and operated in either a private or a public cloud.

The connection [113] optionally passes through a Client Security Logic [104], a Client Firewall [105], a Server Firewall [108], and a Server Security Logic [109]. The Client Security Logic [104] and Server Security Logic [109] are used to provide a means for the Parameter Tuner Gateway [103] and the Parameter Tuning Logic [111] to transmit data safely and securely, such as through a Virtual Private Network (VPN) service over the untrusted Internet, or providing an authentication service for the server and client to authenticate each other. The Client Firewall [105] and Server Firewall [108] are used to provide a means to prevent unwanted transmissions on the connection [113], such as using an Internet firewall that only let connections through certain predesignated ports. Any one or all of the Client Security Logic [104], the Client Firewall [105], the Server Firewall [108], or the Server Security Logic [109] can be omitted if they are not needed. For instance, if the Cloud Tuning Service [106] can already communicate with the client site [101] securely and reliably without the need to use any special device or process, we can omit the Client Security Logic [104], the Client Firewall [105], the Server Firewall [108], and the Server Security Logic [109].

State value is defined to be the data that is relevant to the state of the subject system. The Parameter Tuning Logic [111] takes the state values and parameter values as input, analyzes them, and makes decisions about how to tune the subject system. Theoretically, we can say that all data about and from the subject system are relevant to the state of the subject system, and from a data analysis and machine learning perspective, the more input data we give to the analytic or machine learning algorithm, the more likely we will get better results. In practice, the amount of state values that can be transferred to the Parameter Tuning Logic [111] is limited by the network, or the client may not want to transfer all data of the subject system to a third party, because they can include private or confidential information. The client needs to decide what state values it wants to use and transfer to the Cloud Tuning Service Provider. What kinds of state values the client can get from the subject system depend on the subject system. Different subject system can have different kinds of state values. The client can usually find a list of relevant state values from the subject system's user's manual or tuning guide. Optionally, the client can ask the Cloud Tuning Service provider for a list of commonly used state values that are relevant to its subject system, and, based on this list, add or remove state values. The following list is offered as a sample to help the reader understand what are commonly used state values, and by no means is an exhaustive list; a subject system can usually offer hundreds or thousands of state values that can help to understand its running status: the manufacture and model number of the subject system; the manufacture, model number, and version of each of the component of the subject system; the number of processor units of the subject system; the cache sizes of each processor unit; the bandwidth between the processor unit and memory units; the amount and speed of the memory units; the bandwidth and latency of each network interface card; the size and speed of each storage device; the version of the operating system software that is running on the subject system, the name and version of plugins loaded by the operating system; the log of the hardware and software of the subject system; the utilization rate of each processor of the subject system; the amount of free memory of the subject system; the process scheduler used by the operating system; the amount of power used by the hardware; the real-time throughput of read and write of each storage device, the real-time send and receive throughput of each network interface devices; and many others.

The state values and the existing parameter values of the subject systems [102] are being transmitted at intervals to the Cloud Tuning Service [106]. The Parameter Tuning Logic [111] provides a means for analyzing the state values and the existing parameter values, and/or a means for calculating parameter tuning instructions for the subject systems [102]. A parameter tuning instruction instructs the subject system how to tune one or more parameters. For instance, it can be new values for parameters, or how to change an existing parameter value, or any other instruction that can be used to tune the parameters. These parameter tuning instructions will be transmitted to the Parameter Tuning Gateway [103] or client agents [102] via connection [113] at intervals. The Cloud Tuning Service [106] can optionally contain one or more data stores [110] that provide a means for storing the state values, the existing parameter values, and parameter tuning instructions. The Parameter Tuning Logic [111] can optionally connected to one or more data stores [110] through a data transmission means [117]. Certain cloud provides such as Amazon Web Services provide data storage services, such as Amazon Simple Storage Service and Amazon DynamoDB. These storage services can also be used in place of or in combination with the Data Store(s) [110].

There are many methods to implement the Parameter Tuning Logic [111]. Any methods can be used as long as they meet these requirements:
1. can analyze the input data;
2. can generate parameter tuning instructions, such as new values for parameters or how to change the values of parameters.
   Optionally, the Parameter Tuning Logic [111] can learn over time automatically, through a certain training method, to improve the effect of the generated parameter tuning instructions. Deep Reinforcement Learning (“CAPES: Unsupervised Storage Performance Tuning Using Neural Network-Based Deep Reinforcement Learning”. The 2017 International Conference for High Performance Computing, Networking, Storage and Analysis (Supercomputing 2017), Denver, Colo., USA: Nov. 13-16, 2017) is such a method. And any methods that meet the above requirements can be used.

The Cloud Tuning Service [106] includes a Management Logic [112], which manages the operation of the whole Cloud Tuning Service [106]. The Management Logic [112] has a connection through a data transmission means to all the components of the Cloud Tuning Service [106] that the Management Logic [112] needs to manage, and those connections are omitted in the graph for the sake of clarity. The Management Logic [112] also provides a control interface [115] that connects to a Management Client [118] through a data transmission means, such as a computer network. The control interface [115] to the Management Logic [112] can optionally pass through the Server Firewall [108] and/or the Server Security Logic [109] if the underlying data transmission means is not secure or stable enough. For instance, the Server Security Logic [109] can provide a means to setup a VPN service so that the Management Client [118] can access the Management Logic [112] securely, and the Server Firewall [108] can provide a means to only let through legitimate connections and block all other connections.

The Parameter Tuner Gateway [103] also exposes a management interface [114] that is connected to the Management Client [118] through a means of data transmission, such as a computer network. The Parameter Tuner Gateway's management interface [114] to the Management Logic [112] can optionally pass through the Client Security Logic [104] and/or the Client Firewall [105] if the underlying data transmission means is not secure or stable enough. For instance, the Client Security Logic [104] can provide a means to setup a VPN service so that the Management Client [118] can access the Parameter Tuner Gateway [103] securely, and the Client Firewall [105] can provide a means to only let through legitimate connections and block all other connections.

The Management Client [118] is a component that is being operated by a person for monitoring and managing the tuning method or apparatus. It is a logical unit and can be physically deployed on one or more computers, such as on a laptop for ease of use, or one a desktop computer located inside the customer site for better security. The role for monitoring and managing the components at the client site [101] can be separated from the role for monitoring and managing the Cloud Tuning Service [106], and these roles can be authorized to different computers operated by different users. It is also possible to have multiple users that have different levels of authorization. For instance, a high-level user can have the right to monitor and manage all subject systems, while a low-level users can have the right to monitor and manage a subset of subject systems. In another example, a high-level user can have the right to monitor and manage all systems while a low-level user can only have the right to monitor systems but not manage systems. The separation of role and levels of authorization can be tailored flexibly to match the management structure and requirement of the user organization.

The interface exposed by the Management Logic [112] and the Parameter Tuner Gateway [103] can be a web interface. In this case, the Management Client [118] just need to provide a means to connect to the Management Logic [112] and the Parameter Tuner Gateway [103] reliably and securely, and to provide a means to browse a website. Different users can have different user accounts, which can have different roles and levels of authorization.

The Cloud Tuning Service [106] includes a Billing Logic [107], which manages the billing information for each client. The Billing Logic [107] has a connection through a data transmission means to all the components of the Cloud Tuning Service [106] that are billing related. For instance, the Billing Logic [107] can be connected to the Parameter Tuning Logic [111] and/or the Data Store(s) [110] in order to collect information about the tuning. Information that are related to billing includes but is not limited to the start and end time of the tuning, how many state values are used, how many parameters are being tuned, the length of the interval for inputting the state values and existing parameter values, the interval for calculating the parameter tuning instructions, and how much and how long the historic data is being stored.

The Billing Logic [107] can also be located at the client site [101], depending on what is the most efficient way of implementing the billing logic.

The subject system(s) [102], the Parameter Tuner Gateway [103], the Client Security Logic [104], and the Client Firewall [105] are logical units and are not meant to limit how they are to be deployed physically. For instance, any one of them can be located on one or more computer systems, depending on the situation and technologies that are most fit for the customer site.

Similarly, the Billing Logic [107], Server Firewall [108], the Server Security Logic [109], the data store(s) [110], the Parameter Tuning Logic [111], and the Management Logic [112] are logical units and are not meant to limit how they are to be deployed physically. Depending on the technologies used in the cloud platform, any one of the above logic units can be co-located on one computer, or any one of them can be deployed to more than one computer. For instance, the Parameter Tuning Logic [111] can include one or more computers or virtual machines, depending on the required computational capability. The data store(s) [110] can include one or more computers with one or more storage devices attached, depending on the required storage capacity and capability.

The parameter tuning method may be implemented as a software, for example, an application program, as components of the operating system, as components of the cluster management software, and/or as components of a middleware layer, or as a circuit logic device, or any combination thereof, implementing the parameter tuning process in the foregoing description. In addition, the parameter tuning method, in accordance with the principles of the present embodiment, may include components other than those, and may not necessarily include all components, shown in the exemplary embodiment of FIG. 1.

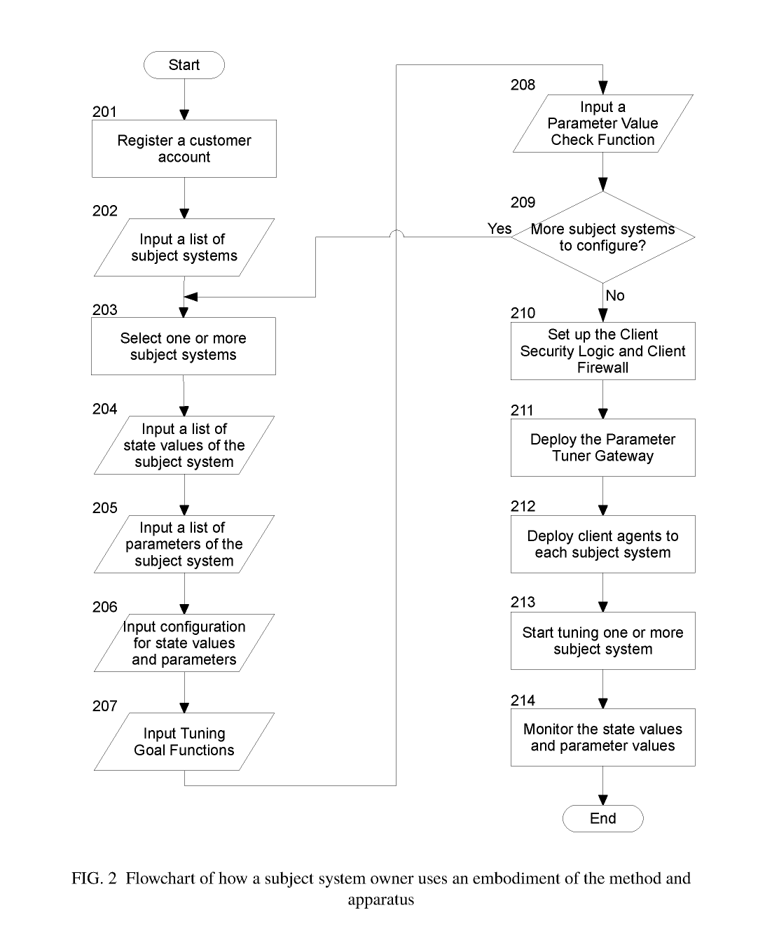

### Operation—FIG. 2

FIG. 2 shows a flowchart of an embodiment of how a user interacts with an embodiment of the cloud parameter tuning method. A user can be an individual or a representative from an organization, such as an employee from the IT department of a company. In Step [201], the user register a customer account of the Cloud Tuning Service [106]. The information that is required for registering the account includes, but is not limited to, the customer's name, contact person, contact email, phone number, and billing information, which is needed to provide a means to bill the customer and can include information such as a credit card number, a bank account number, and/or other payment related information. The account information can also include security configurations, which can include valid IP range of the customer and a means to set up secure data transmission, such as a VPN system, a pre-shared secret key, or any other options that are needed for setting up a secure data transmission means between the client site [101] and the Cloud Tuning Service [106]. The user interacts with the embodiment of the cloud parameter tuning method through a Management Client [118], which can be either a web browser that connects to a web server of the Cloud Tuning Service [106] or a component that is obtained through the people that is operating the Cloud Tuning Service [106]. The data that the user input is stored in the Data Store [110] for later use.

In Step [202], a list of subject systems is input into the system by the user using a Management Client [118]. The user interface of the Management Client [118] can provide a means for the user to input the information of one subject system a time, or to bulk import the information of many subject systems in a batch. The latter can be achieved through any means for store and transmitting information, including but are not limited to, Comma-Separated Values (CSV) files, electronic spreadsheets, or XML files. Each subject system is identified using a means of system identification, such as hostnames or IP addresses. Along with the subject system identification information, more information about each subject system can be input. They include but are not limited to system name, system owner, system up and down time, a list of users that are authorized to use or manage the tuning system, the start/end time for tuning this subject system, and the desired parameter tuning logic. A parameter tuning logic provides a means to calculate parameter tuning instructions by analyzing state values and parameter values that are collected from the subject system. Parameter tuning logic methods include, but are not limited to, reinforcement learning-based methods, feedback control methods, and any other methods that can be used to calculate a tuning instruction or provide new parameter values. Multiple parameter calculation methods can be used at the same time for one subject system (see Step [504] for detail). The user interface of the Management Client [118] can also be used later to add more subject systems. The data that the user input is stored in the Data Store [110] for later use.

In Step [203], the user selects one or more subject system for inputting detailed information of that subject system using a Management Client [118]. The user can choose to modified one or more fields of these selected subject systems in the following steps. If more than one subject systems are selected, the respective field of these subject systems will be modified together.

In Step [204], a list of state values of the subject system that the user select in Step [203] is input into the system. The list includes basic information of each state value from the subject system that should be collected and stored. The list of state values that the user input is stored in the Data Store [110] for later use.

In Step [205], a list of parameters of the subject system that the user select in Step [203] is input into the system. The list includes basic information of each parameter from the subject system that should be collected, stored, and tuned. The list of parameters that the user input is stored in the Data Store [110] for later use.

In Step [206], the user inputs configuration information for each state value and parameter of the lists that the user input in Step [204] and [205]. Each state value and parameter can be configured respectively. A group of state values or parameters can be also configured collectively if they share the same configuration. The configuration of each state value designates how the state value should be collected and displayed. The configuration options of each state value depend on the subject system and can include, but are not limited to, name of the state value, how it should be collected, valid range or set of values, collect interval, and preprocessing instructions. How it should be collected can be a command that can be run on the subject system to collect the value, a file or pipe of a UNIX/Linux operating system from which the value can be read, the name of a program that can be invoked to collect the value, the name of a registry item on the Windows operating system, a data item from a log, a value that can be retrieved from a database, or any other means that can be used to retrieve or collect a state value from the subject system or a connected peripheral or support device. The list and configuration of state values can optionally be copied from an existing subject system to reduce the time and effort that are needed to input them. The configuration of state values that the user input is stored in the Data Store [110] for later use.

Each parameter can be configured separately. A group of parameters can also be configured collectively if they share the same configuration. The configuration options for each parameter depend on the subject system and can include, but are not limited to, name of the parameter, how it should be collected, how it should be set, valid range or set of values, collect interval, time limit of changing the parameter, conditions in which the parameter needs being tuned, and preprocessing instructions. Those configuration options that have the same name as the state values have the same meaning. How a parameter should be set can be a command that can be run on the subject system to set the value, a file or pipe of a UNIX/Linux operating system to which the value can be written to, the name of a program that can be invoked to set the parameter value, the name of a registry item on the Windows operating system, or any other means that can be used to set a parameter's value on the subject system. The time limit of changing the parameter limits when the parameter value can be changed, such as a valid range of time and how often the related parameter can be set. Certain parameters can only be changed during a special window of time, such as only at nights; certain parameters cannot be changed too often, or they could cause negative impact on performance. The frequency limit can be expressed as a maximum frequency or minimum time gap between two changes, or any other means that is appropriate for the specific parameter for limiting the changing time. The conditions in which the parameter needs being tuned is a collection of conditions, and when they are met, the parameter needs being tuned. Samples for such conditions include, but are not limited to, when a certain state value is lower or higher than a threshold, the value of a certain parameter is lower or higher than a threshold, a job of a certain name has started, etc., or any combination of them. The conditions can be expressed in a means that the Parameter Tuning Logic [111] can evaluate, such as one or more boolean equations or a software/hardware component that can be used to check the conditions. The list and configuration of parameters can optionally be copied from an existing subject system to reduce the time and effort that are needed to input them. The configuration of parameters that the user input is stored in the Data Store [110] for later use.

Optionally, in Step [207], the user inputs one or more Tuning Goal Functions for the subject systems that the user select in Step [203]. A Tuning Goal Function provides a means for the Parameter Tuning Logic [111] to decide the goal of the tuning. The Tuning Goal Function can be of various forms. In one embodiment, the Parameter Tuning Logic [111] tune the parameters of the subject system in order to maximize the value of the Tuning Goal Function. For instance, if the value of the Tuning Goal Function equals to a specific state value, the Parameter Tuning Logic [111] would find parameter values that can maximize the specific state value. Sample state values that can be used in this embodiment for the Tuning Goal Function include, but are not limited to, I/O throughput, transaction processing throughput, I/O per second (IOPS), etc. In another embodiment, the value of the Tuning Goal Function can equal to the negative of a state value. In this case, the Parameter Tuning Logic [111] would find parameter values that can minimize the specific state value. Sample state values that can be used in this embodiment include, but are not limited to, I/O latency, transaction process time, power consumption, system temperature, memory consumption, etc. In another embodiment, a Tuning Goal Function can be a function of one or more state values and parameter values, which can provide a means to combine the effect of multiple state values and parameter values. For instance, let p be the I/O throughput of a subject system, l be the latency of the said system, and α is a certain value between 0 and 1, the Tuning Goal Function can be defined as p−α×l. While the Parameter Tuning Logic [111] seeks parameter values that can maximize the value of this Tuning Goal Function, it seeks a combined and balanced effect of higher throughput and lower latency. The Tuning Goal Function can optionally be copied from an existing subject system to reduce the time and effort that are needed to input them. The Tuning Goal Function that the user input is stored in the Data Store [110] for later use.

Optionally, in Step [208], one or more Parameter Value Check functions can be input into the system for the parameters that the user input in Step [205]. The Parameter Value Check functions are used by the Parameter Tuning Logic [111] to check the validity of the calculated parameters tuning instructions before sending them to the subject systems [102]. Those Parameter Value Check functions provide a means for the customer to filter out unwanted values or combination of values of parameters. For instance, for a certain subject system, the user wants the minimum size of a work queue to be proportional to the number of worker threads. That is to say, when you have n worker threads, the size of the work queue, s, should be no smaller than b×n, where b is a predesignated constant. Then the user can input a Parameter Value Check function: s≥b×n, which will be used by the Parameter Tuning Logic [111] to check the newly calculated parameter tuning instructions and see if they meet the user's requirement. The Parameter Value Check Functions can optionally be copied from an existing subject system to reduce the time and effort that are needed to input them. The Parameter Value Check Functions that the user input are stored in the Data Store [110] for later use.

In Step [209], if the user needs to input information for other subject systems, move to Step [203]. If the user has finished inputting information for all subject systems, move to Step [210].

Optionally, in Step [210], the user sets up the Client Security Logic [104] and Client Firewall [105]. The user can use any product or method for the Client Security Logic [104] and Client Firewall [105] as long as they can provide a secure means to connect the client site [101] to the Cloud Tuning Service [106]. For instance, the Cloud Tuning Service provider can provide a means to distribute a VPN client to the client, who can then set up the VPN client on the client site. A variety of methods can be used for the distribution of the VPN client. For instance, the Client Security Logic [104] can be provided as an installation program for popular operating systems, an ISO image for burning an installation disk, an ISO image for burning a Live CD/DVD, an USB disk image for making a bootable USB drive, a virtual machine image, or a container image, such as a Docker image. Other methods for deploying a computer program can also be used. The data of the above methods can be provided through any data transmission means, such as on a website for the user to download.

In Step [211], the user optionally deploys the Parameter Tuner Gateway [103] at the client site [101]. A variety of methods can be used for the distribution and deployment, similar to the methods as used in Step [210].

In Step [212], the user optionally deploys client agents to each subject system [102]. This step is optional and is only needed if the subject system has not already provided a way to collect and transmit the desired state values and parameter values, or to execute parameter tuning instructions. Most distributed systems, such as distributed storage system and High Performance Computing clusters, already include at least one means to collect state values and parameter values, and to set new parameter values as part of the control and monitoring mechanism. In the case that such a means is not already provided, the user can choose to attach or install client agents to the subject systems. A client agent can be either a software component or a hardware device that can be added to a computer or electronic system to collect the system's state values and parameter values, to set new parameter values, or to execute parameter tuning instructions. The Cloud Tuning Service [106] can provide software client agent for popular subject systems, such as the Windows Operating System, the IBM GPFS Cluster File System, or Android smartphones. A variety of methods can be used for the distribution and deployment of the client agents, similar to the methods as used in Step [210].

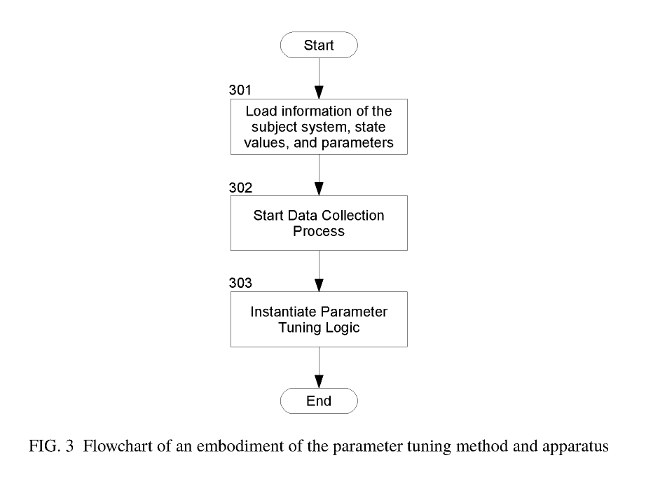

In Step [213], the user starts the parameter tuning process (FIG. 3) for one or more subject systems.

In Step [214], optionally, the user can monitor the state values and the parameter values. This can be done through any means that can deliver data or notification to the client, such as using the Management Client [118] or through emails that are sent out by the Cloud Tuning Service [106].

### Operation—FIG. 3

FIG. 3 shows an operational flowchart of an embodiment of the cloud parameter tuning method. The flowchart shows the operation steps for each subject system that user has set up using steps in FIG. 2. For instance, if the user has input three subject systems, three instances of the operations as shown in FIG. 3 would need to carried out respectively for each subject system.

In Step [301], the Management Logic [112] and the Parameter Tuning Logic [111] load information of the subject system, state values, and parameters from the Data Store [110] into their memory. Only necessary information is loaded, and not all information has to be loaded. Different components can load different information according to their respective logic. The configuration information of state values and parameters are also transmitted to the Parameter Tuner Gateway [103] and/or client agents on the subject system [102] through connection [113]. The Parameter Tuner Gateway [103] and/or client agents on the subject system [102] need these information to decide when and how to collect the state values and the parameter values, and when and how to set the new parameter values. If the client site does not have a Parameter Tuner Gateway [103], these information are directly passed to the subject system or the client agents [102].

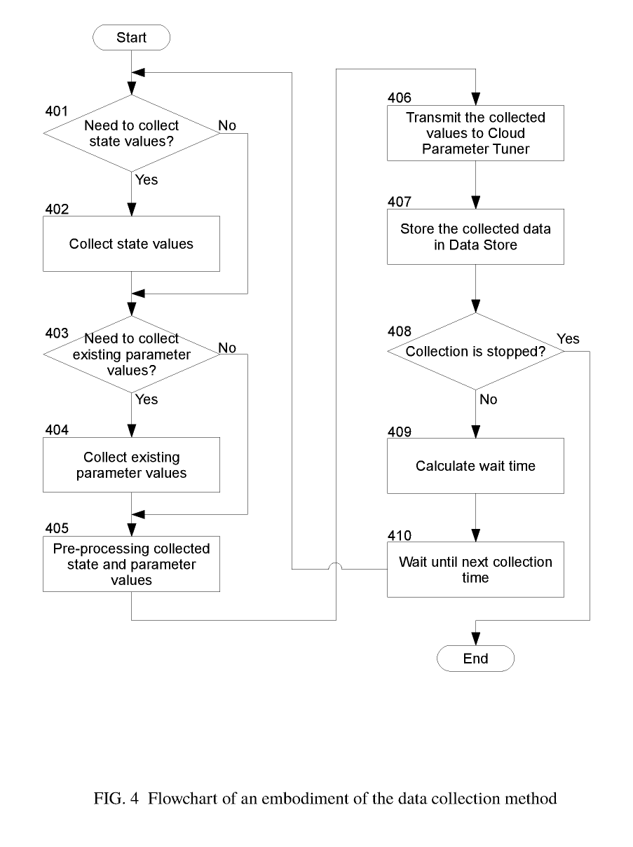

In Step [302], the Management Logic [112] or the user starts the data collection process (FIG. 4). Management Logic [112] decides when to start the collection process according to the configuration of state values and parameters. The configuration of state values and parameters include information that was input by the user in Step [206] and can designate the conditions to start the data collection process, such as a time period. The data collection process can also be started by the user on demand. One embodiment of the operation of the data collection process is shown in FIG. 4.

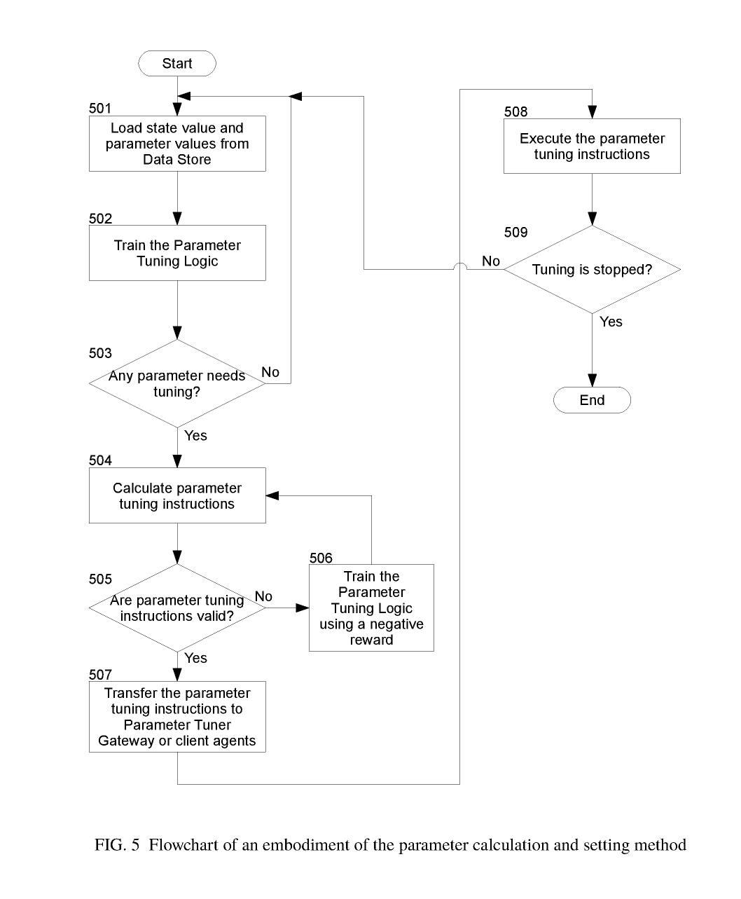

In Step [303], the Cloud Tuning Service [106] allocates instances of the Parameter Tuning Logic [111]. The allocation is done either by starting a new instance of the Parameter Tuning Logic [111] software on existing nodes that are shared with other components, or on new nodes that are acquired from the underlying cloud platform. One embodiment of the operation of the Parameter Tuning Logic [111] is shown in FIG. 5.

### Operation—FIG. 4

FIG. 4 shows an operational flowchart of an embodiment of the data collection process that is started in Step [302].

In Step [401], each client agent checks if there is a need to collect state values by using the information that was transmitted to them in Step [301]. As set by the user in Step [206], the configuration of state values includes conditions under which their values should be collected. These conditions can include but are not limited to, the time to start collect the values and how often the values should be collected. Each client agent checks the conditions on the subject system node(s) it is connected to (or running on), and if the conditions are satisfied, move to Step [402]. If there is no need to collect any state value, move to Step [403].

In Step [402], each client agent collects the state values of which the related collecting conditions are met in Step [401]. The collected values can optionally be transmitted to the Parameter Tuner Gateway [103] if the client site has a Parameter Tuner Gateway. Alternatively, the client agent can buffer the collected values in its memory for future processing and/or transmission.

In Step [403], each client agent checks if there is a need to collect parameter values by using the information that was transmitted to them in Step [301], similar to Step [401]. As set by the user in Step [206], the configuration of parameters includes conditions under which their values should be collected. These conditions can include but are not limited to, the time to start collect the values and how often the values should be collected. Each client agent checks the conditions on the subject system node(s) it is connected to (or running on), and if the conditions are satisfied, move to Step [404]. If there is no need to collect any parameter value, move to Step [405].

In Step [404], each client agent collects the parameter values of which the related collecting conditions are met in Step [403]. The collected values can optionally be transmitted to the Parameter Tuner Gateway [103] if the client site has a Parameter Tuner Gateway. Alternatively, the client agent can buffer the collected values in its memory for future processing and/or transmission.

In Step [405], the collected data are preprocessed according to the preprocessing method the user configured for the state values and parameters in Step [206]. The preprocessing step is an optional step that can be used to process collected state values and parameter values before transmission and/or before being stored in the Data Store [110]. The preprocessing can be done in either the client agents [102], the Parameter Tuner Gateway [103], the Parameter Tuning Logic [111], and/or the Data Store [110], depending on what method fits the specific parameter's preprocessing requirement. For instance, a state value can be defined to be the average of values that are measured from the subject system over a period of time. Storage I/O throughput in a storage system is such a state value if it requires summarizing and averaging the size of data that was read and written over a period of time. Doing the summarizing and averaging calculation in the Parameter Tuner Gateway [103] can reduce the data size that needs to be transmitted over connection [113] to the Cloud Tuning Service [106], because the aggregated resultant value would be smaller than the size of data before the processing. Another preprocessing method that is often needed is to compress the data before transmission in order to reduce the data size that needs to be transmitted. Similar processing can also be done at the Data Store [110] before storing the data for purposes include, but are not limited to, compressing data to reduce space, remove data redundancy, aggregating data from multiple subject systems, etc. Optionally, the Cloud Tuning Service [106] can send a function on demand to the Client Site [101] to preprocess the state values and/or the parameter values.

In Step [406], the collected state values and parameter values, after being optionally preprocessed, are transmitted to the Cloud Tuning Service [106] through connection [113].

In Step [407], the data that are being passed through connection [113] are being stored in the Data Store [110]. Optionally, the data can be processed before being stored according to the state values' and parameters' configuration information.

Step [408] checks if the collection process has been instructed to stop. The stop instruction can be determined by conditions that the user set for each subject system in Step [202], be instructed by the user or system administrator directly, or through any other means that can communicate with the Cloud Tuning Service [106]. If the collection process has been instructed to stop, end the process. If not, move to Step [409].

In Step [409], the configuration information of all state values and parameters are used to calculate the next time when any state value or parameter value needs to be collected. This calculate can be done in the client agent that is attached to the subject system [102], or at other appropriate places. The method then wait for that calculated time duration in Step [410], before moving back to Step [401].

### Operation—FIG. 5

FIG. 5 shows an operational flowchart of an embodiment of the parameter calculation and set method that is started in Step [303].

In Step [501], the Parameter Tuning Logic [111] loads the data that is necessary for the calculation from the Data Store [110] into the Parameter Tuning Logic's memory. These data usually include the latest data that was added into the Data Store as well as some historic data.

In Step [502], optionally, the Parameter Tuning Logic [111] performs a training step using the data that was loaded in Step [501]. Whether this step is necessary depends on the means that the Parameter Tuning Logic [111] uses to calculate the parameter tuning instructions. For instance, if a reinforcement learning-based method is chosen for parameter calculation, it could need access to historic state values and parameter values in order to train (construct) a decision table or a neural network that can be used to calculate new parameter values. This step can be skipped if the chosen parameter calculation method does not require a training step.

In Step [503], Parameter Tuning Logic [111] checks if any parameter needs tuning. A parameter can become in need of tuning based on one or more conditions as set in Step [206]. Examples of such conditions include a specific time range or a frequency. The conditions can be checked against the latest time, state values, and parameter values as stored in the Data Store [110] and retrieved in Step [501]. If there's no parameter needs tuning, move to Step [501], else move to Step [504].

In Step [504], Parameter Tuning Logic [111] calculates parameter tuning instructions using the parameter calculation methods for the subject system as set in Step [202]. Certain parameter calculation methods output a desired parameter value; while other parameter calculation methods may output an instruction for changing the parameter instead of a value. For instance, a parameter calculation method can output an instruction that says “increase Parameter A's value by 5”, and another method can output an instruction that says “change Parameter A's value to 20”.

In Step [505], the parameter tuning instructions as calculated by the parameter calculation methods are checked against the Parameter Value Check functions as input by the user in Step [208]. For each parameter, when multiple parameter calculation methods are used together and their outputs are different, only the results that are checked as valid are considered candidate values. When there are more than one candidate parameter tuning instructions, a selection means can be used to choose the final parameter tuning instruction. Such means include, but are not limited to, a score-based ranking method if the parameter calculation methods involved can output a score that is based on expected tuning outcome for their calculated parameter tuning instruction, an averaging method where all candidate parameter tuning instructions are combined and the average value is used as the final parameter tuning instruction, a voting method where the parameter tuning instruction that is chosen by most parameter calculation methods will be chosen as the final parameter tuning instruction, or any other means that can be used to decide between multiple candidate instructions. When a valid parameter tuning instruction is chosen, move to Step [507].

Optionally, in Step [506], the calculated parameter values that failed the validity check in Step [505] are combined with a negative reward and are used to train the related parameter calculation methods that generated these invalid values in Step [504].

In Step [507], the parameter tuning instructions are transmitted to the Parameter Tuner Gateway [103]. The data can be compressed before transmission to reduce data size and transmission cost. If the client site does not have a Parameter Tuner Gateway [103], the parameter tuning instructions can be directly transferred to the subject system or the client agents on the subject systems [102].

In Step [508], the parameter tuning instructions are being executed to change the parameter values on the subject system. These instructions will be executed by the subject system if the system supports executing these instruction. Otherwise, these instructions are executed by the client agents [102], which change the values of the parameters on the subject system. If the client agents [102] receive more than one set of parameter tuning instructions from many parameter tuning logic, the client agents can use a certain consolidating method to generate one set of final parameter tuning instructions and then execute this set of final parameter tuning instructions. Ranking the parameter tuning instructions according to certain criteria, such as expected performance gain, taking average of multiple tuning instructions, and using ensemble learning (Zhou Zhihua (2012). Ensemble Methods: Foundations and Algorithms. Chapman and Hall/CRC. ISBN 978-1-439-83003-1) to aggregate multiple tuning instructions, and any methods that can consolidate multiple sets of instructions can be used.

Step [509] checks if the parameter calculation and setting process has been instructed to stop. The stop instruction can be determined by conditions that the user set for each subject system in Step [202], be instructed by the user or system administrator directly, or through any other means that can communicate with the Cloud Tuning Service [106]. If the parameter calculation and setting process has been instructed to stop, end the process. If not, move to Step [501]. When the process ends, the related Parameter Tuning Logic [111] can be deallocated, which usually involves ending the software process of the related Parameter Tuning Logic [111] instances and returning unneeded computer nodes to the cloud platform.

It is intended that all matter contained in the above description and shown in the accompanying drawings shall be interpreted as illustrative and not in a limiting sense.

### Advantages

From the description above, a number of advantages of some embodiments are evident:
(a) The use of a Cloud Tuning Service will reduce the up-front infrastructural cost of a client for purchasing hardware and software that are needed for running the computational intensive analytic programs. The client will only need to pay according to how they use the service.
(b) The use of client agents and a Cloud Tuning Service will enable parameter tuning on almost any system, no matter if it supports being managed by a cloud platform. The use of a Cloud Tuning Service will move the computational intensive parameter tuning logic to the cloud, making it possible to tune the parameters of a subject system without requiring any computational power from the subject system or its peripheral systems.
(c) The use of a Cloud Tuning Service will reduce the human cost for the initial setup and maintenance of an onsite parameter tuning system. The amount that the client needs to pay the Cloud Tuning Service provider will be much lower than the up-front infrastructural purchase cost and human cost.
(d) The client will not have to worry about those factors that can affect the reliability of the parameter tuning system, such as power supply, hardware reliability, software upgrading, etc. These issues have been taken care of by the Cloud Tuning Service provider.
(e) The client will not need to possess special knowledge of setting up a complex parameter tuning system. This makes it possible for a non-IT specialist, such as an average office worker, to set up a tuning system using the service provided by a Cloud Tuning Service provider.
(f) The use of a Cloud Tuning Service will greatly shorten the time the client will need to deploy the tuning service.
(g) The use of a Cloud Tuning Service will reduce the planning cost of the tuning system of the client. There will be no need for the client to plan ahead about the capacity and capability of the tuning system, such as calculating how many servers or applications are going to be deployed or how long they will need to be tuned, because they will be able to connect as many systems as they want to the Cloud Tuning Service. The client can even enable tuning on all old and new systems without having to worry about the capacity and capability of the tuning system.
(h) The client will be able to experiment with different tuning methods without paying for the up-front infrastructural cost for setting them up. It is very hard to tell which parameter calculation method works best for a certain system without actually testing out the method. In the past, testing a parameter calculation method requires setting up everything under the guidance of a domain expert, which is by itself a very costly endeavor. The use of a Cloud Tuning Service will enable a client to set up the tuning system in minutes, and can easily switch to different parameter calculation methods. This enables the client to conveniently try out different tuning methods and find one that best suits its systems. It will make it possible for the client to use different tuning methods for different subject systems. It will also make it possible to use more than one tuning methods in tandem for one subject system, which can be enabled by using an ensemble learning method to combine the output of several machine learning algorithms.
(i) As a Cloud Tuning Service provider, the costs for the infrastructure, the maintenance of the tuning service, and the development of tuning methods will be spread out to many clients. The cost of maintaining redundant systems for providing high availability can also be reduced because these redundant systems can be shared between many clients.
(j) A client can use the Cloud Tuning Services from more than one Cloud Tuning Service provider. This can have multiple advantages, such as bargaining for a better price, comparing tuning results from different providers, using an ensemble learning method to combine methods from different providers, and high availability so that when one provider has an outage, the client can switch to a different provider.
(k) Supporting many clients enables the Cloud Tuning Service provider to perform cross-system and cross-client machine learning and analytic service. Having access to more data is usually a key factor for designing a successful analytic and machine learning method, and can usually lead to many improvements, such as shortened model training time, more accurate models, better handling of rarely seen inputs, etc.
(l) A client can set up a private Cloud Tuning Service to provide tuning service to systems that are owned by client. If the client is managing a large number of systems, a private cloud can also benefit from the advantages that we have described above, with the extra benefit of privacy: the data about the client's systems will not enter any public service and never have to leave the client's control.
(m) Transmitting and storing the historical state values and parameter values of a subject system in the cloud will make it easier for the client to use cloud-based analytic services. Data visualization, remote system monitoring, outage detection and prediction, performance regression identification, and many other analytic services require access to large amount of state values from the subject system. With the state values of the subject system already available in the cloud, it will be easier to perform any service that needs access to these data, and the client will not need to transfer or store them again.
(n) Storing historical state values in the cloud will make it easier to perform security audit. In the case of a security breach at the client's site, the intruder could gain access to most systems on the client site and change/destroy any data that are stored on site. For comparison, a Cloud Tuning Service can afford to (and all reputable cloud service providers do) hire top security experts and implement high levels of security measures, making it very hard for intruders to breach into the cloud and cause damage. The information from the state values, such as system logs, would be useful for audit in the case of security breach and the on-site data is no longer to be trusted.
(o) Using a Cloud Tuning Service will make it possible for the client to enable tuning only when a certain conditions are met. For instance, the client can choose to enable performance tuning only during the heavy workloads are expected. For a retail website, it could enable tuning only during Black Fridays. For an enterprise storage system, it could enable tuning only during business hours. Because a client only needs to pay for how it uses the tuning service, only using the service when tuning is needed can greatly reduce the cost for the client. For clients who need to reduce the tuning cost to the absolutely minimum, it is possible to use a Cloud Tuning Service to tune the client's systems for a few hours, save the good parameters values, and stop using the Cloud Tuning Server but keep the parameter values.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine. Such as a general-purpose or special-purpose processor or logic circuits programmed with the instructions to perform the methods. These machine-executable instructions may be stored on one or more machine readable mediums. Floppy diskettes, CD-ROMs or other type of optical disks, Read Only Memories (ROMs), Random Access Memories (RAMs), memory, or other types of machine-readable mediums can be used. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

It is also to be understood that the following claims are intended to cover all of the generic and specific features of the embodiments herein described and all statements of the scope of the invention which, as a matter of language, might be said to fall therebetween.

What is claimed:

1. A method for tuning the parameters of a subject system, the method comprising:
identifying status values of the target system to collect, parameters of the subject system to tune, a tuning goal, and a parameter tuning logic; and
deploying the parameter tuning logic in one or more clouds or reusing one or more existing instances of the parameter tuning logic in one or more clouds; and
reading the state values and the parameter values (values of the said parameters) of the subject system at intervals; and
transmitting the state values and the parameter values of the subject system to the clouds at intervals; and
computing parameter tuning instructions by the parameter tuning logic at intervals; and
transmitting the parameter tuning instructions from the clouds to the subject system at intervals; and
executing the parameter tuning instructions at intervals.

2. A method as claimed in claim 1 further comprising:
deploying one or more client agents to the subject system with instructions to read the statue values, and to read and set parameter values of the subject system; and
reading the state values and the parameter values of the subject system by the client agent at intervals; and
executing the parameter tuning instructions by the client agents at intervals.

3. A method as claimed in claim 1 further comprising:
allocating resources from one or more public or private clouds when needed; and
releasing the resources when they are no longer needed.

4. A method as claimed in claim 1 further comprising:
counting the duration of a subject system's tuning time, the number of the state values, and/or the number of parameters the tuning involves to decide how much the subject system owner should pay for the service.

5. A method as claimed in claim 1 wherein the start and stop of steps in the method are controlled by one or more conditions.

6. A method as claimed in claim 1 further comprising:
storing the state values, the parameter values, and the parameter tuning instructions in a data store.

7. A method as claimed in claim 1 wherein the computing of parameter tuning instructions further comprising:
using one or more machine learning or artificial intelligence methods to analyze the state values and the parameter values at intervals; and
training one or more models using the state values, the parameter values, and the parameter tuning instructions from one or more subject systems at intervals; and
generating parameter tuning instructions at intervals.

8. A method as claimed in claim 7 wherein the machine learning methods use one or more deep reinforcement learning methods.

9. A method as claimed in claim 1 further comprising:
inputting one or more Parameter Value Check functions; and
using Parameter Value Check functions to check the parameter tuning instructions before executing them.

10. A method as claimed in claim 9 further comprising:
assigning negative rewards to the parameter tuning instructions that were ruled out by the Parameter Value Check functions; and
using the negative rewards and coupled parameter tuning instructions to train the parameter tuning logic.

11. A method as claimed in claim 1 further comprising:
preprocessing the state values, the parameter values, or the parameter tuning instructions to reduce their sizes before transmission and/or being stored.

12. A method as claimed in claim 1 further comprising:
consolidating parameter tuning instructions from many parameter tuning logic.

13. A apparatus for tuning the parameters of a subject system, the apparatus comprising:
an input means for selecting status values of the target system to collect, parameters of the subject system to tune, a tuning goal, and a parameter tuning logic; and
a data transmission means for instructing one or more clouds to deploy the parameter tuning logic or reuse one or more existing instances of the parameter tuning logic; and
a collection means for collecting the subject system's state values and parameter values at intervals; and
a data transmission means for transmitting the subject system's state values and parameter values to the clouds at intervals; and
a data transmission means for transmitting the parameter tuning instructions generated by the parameter tuning logic in the clouds to the subject system at intervals; and
an execution means for executing the parameter tuning instructions at intervals; and
wherein the parameter tuning logic generates parameter tuning instructions at intervals when deployed.

14. A apparatus as claimed in claim 13, further comprising:
one or more client agents that are attached to the subject system for collecting state values and parameter values, and executing parameter tuning instructions at intervals.
optionally, one or more gateways for processing the state values, the parameter values, and/or parameter tuning instructions that are being transmitted between the clouds and the client agents or subject system.

15. A apparatus as claimed in claim 13, further comprising:
a data storage means for storing the state values, parameter values, and parameter tuning instructions.

16. A apparatus as claimed in claim 13 wherein the parameter tuning logic comprises:
a processor; and
a memory coupled with and readable by the processor and storing a set of instructions which, when executed by the processor, causes the processor to generate parameter tuning instructions by:
using one or more machine learning or artificial intelligence methods to analyze the state values and the parameter values at intervals; and
training one or more models using the state values, the parameter values, and the parameter tuning instructions from one or more subject systems at intervals; and
generating parameter tuning instructions at intervals.

17. A apparatus as claimed in claim 16 wherein the machine learning methods contain one or more deep reinforcement learning methods.

18. A apparatus as claimed in claim 13 further comprising:
an input means for inputting one or more Parameter Value Check functions; and
a processor, and a memory coupled with and readable by the processor and storing the Parameter Value Check functions which, when executed by the processor, causes the processor to check the parameter tuning instructions before executing them.

19. A apparatus as claimed in claim 13 further comprising:
a billing component that calculates how much a client should pay according to its use of the service.

20. A apparatus as claimed in claim 13 further comprising:
a processor, and a memory coupled with and readable by the processor and storing a set of instructions which, when executed by the processor, causes the processor to consolidate multiple sets of parameter tuning instructions from multiple parameter tuning logic.
